(19) United States
(12) Patent Application Publication
(10) Pub. No.: US 2025/0200925 A1
(43) Pub. Date: Jun. 19, 2025

(54) DYNAMICALLY GENERATING A REGION OF INTEREST (ROI) FOR A THERMAL CAMERA

(71) Applicant: INTERNATIONAL BUSINESS MACHINES CORPORATION, Armonk, NY (US)

(72) Inventors: Raghu Ramaswamy, Bangalore (IN); Jignesh Karia, Thane (IN); Prasanna Jirafe, Pune (IN); Syed Abdul Kader, Triunelveli (IN); Nancy Anne Greco, Lagrangeville, NY (US); Shiva G, Bangalore (IN); Kay Murphy, Nebo, NC (US)

(21) Appl. No.: 18/538,241

(22) Filed: Dec. 13, 2023

(51) Int. Cl. G06V 10/25; G01J 5/00; G01J 5/48; G06T 7/00; G06T 7/50; G06V 10/70; G06V 10/94; G06V 20/50

(52) U.S. Cl. CPC G06V 10/25; G01J 5/48; G06T 7/0002; G06T 7/50; G06V 10/70; G06V 10/945; G06V 20/50; G01J 2005/0077; G06T 2207/10048; G06T 2207/20081; G06T 2207/20104; G06V 2201/10

(57) ABSTRACT

A method, system, and computer program product are configured to: receive camera data from a thermal camera; determine a suggested region of interest (ROI) using the camera data, an object detection model, an anomaly detection model, and a shape recommendation model; determine a final ROI using the suggested ROI and a selection rule; and communicate the final ROI to the thermal camera.

### BACKGROUND

Aspects of the present invention relate generally to thermal imaging.

A thermal camera captures and creates an image of an object by using infrared radiation emitted from the object in a process that is called thermal imaging. The analysis of a thermal image is focused on certain portions of the image known as regions of interest (ROIs). A temperature value extracted (e.g., typically a minimum, maximum, and average temperature) from the ROI provides input for meaningful conclusions.

There are many applications of thermal imaging across industries. For example, power line maintenance technicians may use thermal imaging to locate overheating joints and parts to eliminate potential failures. Building construction technicians may use thermal imaging to see heat leaks to improve the efficiencies of cooling or heating. Healthcare practitioners may monitor physiological activities, such as fever, in human beings and other warm-blooded animals with thermal imaging.

### SUMMARY

In a first aspect of the invention, there is a computer-implemented method including: receiving, by a processor set, camera data from a thermal camera; determining, by the processor set, a suggested region of interest (ROI) using the camera data, an object detection model, an anomaly detection model, and a shape recommendation model; determining, by the processor set, a final ROI using the suggested ROI and a selection rule; and communicating, by the processor set, the final ROI to the thermal camera.

In another aspect of the invention, there is a computer program product including one or more computer readable storage media having program instructions collectively stored on the one or more computer readable storage media. The program instructions are executable to: receive camera data from a thermal camera; determine a suggested region of interest (ROI) using the camera data, an object detection model, an anomaly detection model, and a shape recommendation model; determine a final ROI using the suggested ROI and a selection rule; and communicate the final ROI to the thermal camera.

In another aspect of the invention, there is a system including a processor set, one or more computer readable storage media, and program instructions collectively stored on the one or more computer readable storage media. The program instructions are executable to: receive camera data from a thermal camera; determine a suggested region of interest (ROI) using the camera data, an object detection model, an anomaly detection model, and a shape recommendation model; determine a final ROI using the suggested ROI and a selection rule; and communicate the final ROI to the thermal camera.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

### DETAILED DESCRIPTION

Aspects of the present invention relate generally to thermal imaging and, more particularly, to automatically generating regions of interest (ROIs) in thermal imaging. In accordance with aspects of the invention, there is a comprehensive closed looped camera system that can identify a set of ROIs dynamically and continuously tune the ROIs to reduce human intervention or human error. In embodiments, the system includes a ROI engine (e.g., an orchestrator), a set of artificial intelligence (AI) models (e.g., including an object detection model, an anomaly detection model, and a recommendation model), and a configurable rules engine. In embodiments, the AI models are built using multiple data inputs such as optical image data, thermal image data, thermal data, historical thermal data, asset maintenance history (e.g., prior failures or repairs), asset real-time condition data, asset specification data, and asset event data. In embodiments, a rule-based filter is applied based on a model confidence level. In embodiments, human validation is triggered when the confidence score is less than the pre-defined threshold. In embodiments, the system provides closed looped integration with a camera to supply the camera with new (e.g., updated) ROI coordinates.

The task of defining a ROI often requires subject matter expertise or domain experience. There are often inaccuracies in thermal image monitoring due to incorrect ROI definition (e.g., in size and/or shape) or missing a ROI altogether. In all cases, regular calibration and validation of a ROI is important to produce consistent and accurate results. The task of defining a ROI is typically performed manually by a user utilizing a computer interface to manually draw a bounding box that defines the ROI. If the user is not a subject matter expert (SME) or does not possess domain knowledge regarding what is being monitored with the thermal imaging, then the user is prone to define a sub-optimal ROI that does not encompass a useful region of the image. Moreover, even a well-placed ROI drawn by an SME or user with domain knowledge can become outdated and sub-optimal due to the changing nature of the thermal properties of the object being monitored. This is because manually drawn ROIs are static and are not able to change with changing thermal conditions of the object being monitored.

Implementations of the present disclosure address these issues by providing a method, system, and computer product that are configured to: remotely determine a ROI based on received information and apply artificial intelligence (AI) or machine learning (ML) to define a ROI and correction of a ROI on an end device; dynamically identify the areas of interest and provide predictive insights to take corrective action; dynamically generate a region of interest using AI/ML models along with the confidence scores in order to support assist scenarios; leverage metrics such as optical image data, asset specification data, thermal data, and historical trends in order to derive and recommend a ROI dynamically; project dynamic selection of a ROI (e.g., in the form of a free form or shape) based on various metrics including rules; dynamically update the ROI providing closed loop integration with the end device (e.g., thermal camera); and automate the creation and maintenance of a ROI process using AI models (including an object detection model, an anomaly detection model, and a recommendation model) and a configurable rules engine.

In particular, implementations of the present disclosure address the above-noted issues by providing a method, system, and computer product that are configured to: receive camera data from a thermal camera; determine a suggested ROI using the camera data and an object detection model, an anomaly detection model, and a shape recommendation model; determine a final ROI using the suggested ROI and a selection rule; and communicate the final ROI to the thermal camera. By determining a ROI using thermal camera data, an object detection model, an anomaly detection model, and a shape recommendation model, implementations provide for automated determination of the ROI based on trained models, which is an improvement in the technical field of thermal imaging because it reduces or eliminates the above-noted problems involved in manually selecting a ROI. Moreover, by communicating the final ROI back to the thermal camera, implementations provide for dynamically updating the ROI to keep up with changing thermal conditions of the object being monitored, which is an improvement over systems that use a static ROI defined manually. Implementations may thus provide improvements in the form of: a significant reduction of catastrophic asset failure and an improvement of asset uptime by providing early warnings for taking corrective action; reducing costs of maintenance; reducing time for inspection; permitting a person with less experience to use the system confidently; being non-intrusive and not needing changes to equipment that is being monitored; producing high accuracy results based on domain knowledge, current data, and historical data; involving a human-in-the-loop when dictated by the rules engine; providing capability for human to set the rules for selection of an appropriate right ROI shape (e.g., free form, rectangular, or point); providing a cross-industry solution; and providing a solution that can be used with any make and/or model of thermal camera.

Implementations of the invention are necessarily rooted in computer technology. For example, the step of determining a suggested ROI using camera data and an object detection model, an anomaly detection model, and a shape recommendation model ROI is computer-based and cannot be performed in the human mind. Training and using such AI and ML models are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as region of interest code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

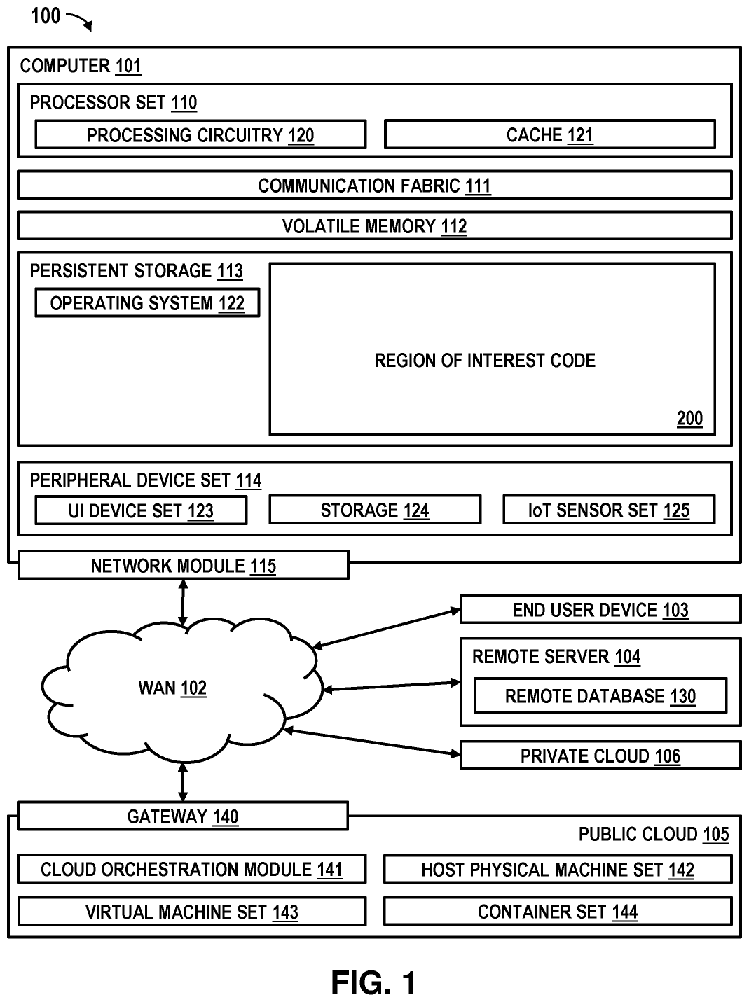

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

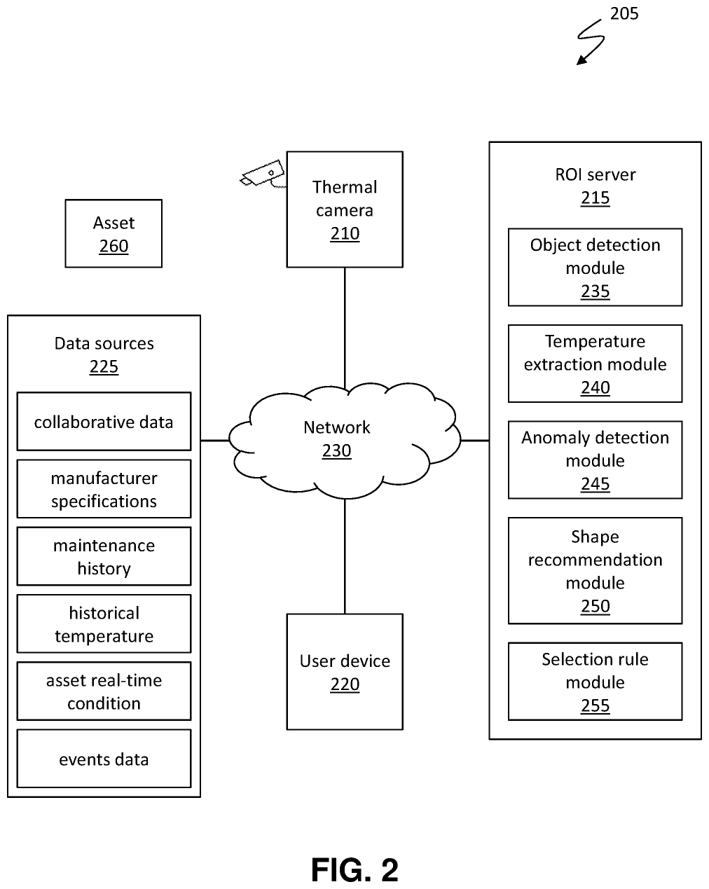

FIG. 2 shows a block diagram of an exemplary environment 205 in accordance with aspects of the invention. In embodiments, the environment 205 includes a thermal camera 210, a ROI server 215, a user device 220, and data sources 225. The thermal camera 210 may comprise one or more conventional or later developed cameras that are capable of capturing optical image data and thermal image data in a field of view. In one example, the ROI server 215 comprises one or more instances of the computer 101 of FIG. 1. In another example, the ROI server 215 comprises one or more virtual machines or one or more containers running on one or more instances of the computer 101 of FIG. 1. The user device 220 may comprise one or more instances of the EUD 103 of FIG. 1. The data sources 225 may comprise one or more instances of the remote database 130 of FIG. 1. In embodiments, the ROI server 215 communicates with each of the thermal camera 210, the user device 220, and the data sources 225 via a network 230, which may comprise the WAN 102 of FIG. 1.

In embodiments, the ROI server 215 of FIG. 2 comprises an object detection module 235, temperature extraction module 240, anomaly detection module 245, shape recommendation module 250, and selection rule module 255, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The ROI server 215 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the thermal camera 210 is configured to capture thermal images of an asset 260 where the thermal images are used in thermal monitoring of the asset. Non-limiting examples of assets include electrical devices such as transformers and machinery such as motors. Non-limiting examples of monitoring include detecting a failure that has occurred and predicting a failure that has not yet occurred, wherein a failure may include a thermal, structural, or electrical failure of one or more components of the asset 260. In embodiments, the thermal camera 210 captures image data of the asset 260 and transmits the image data to the ROI server 215. In embodiments, the image data includes optical image data (e.g., image data in the visible spectrum) and thermal image data (e.g., image data in the infrared spectrum). In embodiments, the thermal camera 210 also transmits metadata to the ROI server 215, where the metadata corresponds to the optical image data and/or the thermal image data. The metadata may include data that defines a ROI used by the camera when monitoring the asset 260. The metadata may also include information such as a make and/or model of the asset 260.

In accordance with aspects of the invention, the object detection module 235 is configured to detect an object in the optical image data using an object detection model, and to generate an initial ROI based on the detected object. In embodiments, the object detection model is trained using asset type information to detect predefined objects (e.g., components) of the asset 260. For example, if the asset 260 is a motor, the object detection model may be trained to detect components of a motor such as a housing, cooling fan, gear housing, shaft bearing, and pump. The object detection model may comprise an AI or ML model that uses edge detection techniques to detect one or more objects in the optical image data received from the thermal camera 210. In embodiments, based on detecting an object in the optical image data, the object detection module 235 generates an initial ROI based on the detected object, such as a bounding box that surrounds an entirety of the detected object. After detecting an object using the trained object detection model, the object detection module 235 may generate a bounding box around the detected object using any conventional or later developed technique.

Although a single detected object and a single initial ROI are described herein for simplicity, it is understood that the object detection module 235 may detect plural objects (e.g., components) of the asset 260 in the optical image data, and may generate a respective initial ROI for each respective object. In this manner, a set of initial ROIs may include one or more initial ROIs corresponding respectively to one or more detected components of the asset 260.

In accordance with aspects of the invention, the temperature extraction module 240 is configured to extract temperature information from the thermal image data in the initial ROI. In embodiments, the temperature extraction module 240 receives data from the object detection module 235, wherein the data defines the initial ROI of the detected object. The data may comprise, for example, coordinate data of a bounding box of the initial ROI. In embodiments, the temperature extraction module 240 uses thermal imaging temperature detection techniques to extract temperatures from a region of the thermal image data that corresponds to the are defined by the initial ROI. The temperature extraction module 240 may perform this for all initial ROIs.

In accordance with aspects of the invention, the anomaly detection module 245 is configured to generate an intermediate suggested ROI using an anomaly detection model with the initial ROI (from the object detection module 235), the extracted temperature information (from the temperature extraction module 240), and additional information from the data sources 225. In embodiments, the intermediate suggested ROI is a modified version of the initial ROI or a new region of interest. The anomaly detection module 245 may perform this for all initial ROIs.

In embodiments, the anomaly detection model used by the anomaly detection module 245 comprises an ensemble model that includes plural anomaly detection models, and the intermediate suggested ROI is generated using a highest-ranked one of the plural anomaly detection models. Different ones of the plural anomaly detection models are trained to detect anomalies in different types of time series data. These models may be built using both supervised and unsupervised techniques. In one example, a supervised model is trained using supervised learning algorithms with labeled anomaly data in various types of data in the data sources 225. Such supervised models may include but are not limited to supervised neural networks, support vector machine learning, k-nearest neighbors, Bayesian networks, and decision trees. In another example, unsupervised models included in the anomaly detection model are trained using techniques such as linear regression or logistical regression models. In embodiments, the anomaly detection model uses an ensemble approach to score (e.g., using values from 1 to 10) each individual model based on pre-defined criteria, and a threshold on the score (e.g., a score greater than 8) is leveraged to select the best output. In this manner, the intermediate suggested ROI is generated using a highest-ranked one of the plural anomaly detection models.

In embodiments, the additional information in the data sources 225 includes collaborative data, content data, and context data. In embodiments, the collaborative data comprises data from a same family of asset as the detected object. In embodiments, the content data comprises one or more selected from a group consisting of: manufacturer information or specifications of the asset or the detected object; maintenance history data; historical temperature data; and asset real-time condition data. Manufacturer information or specifications may include information that defines normal operation conditions of different parameters of the asset 260. Maintenance history data may include data that defines a history of maintenance events performed on the asset 260. Historical temperature data may include time series data of past detected temperatures of the asset 260, wherein each data set in the time series includes a temperature and a coordinate location on the asset 260. Asset real-time condition data may include time series data of past detected conditions of the asset 260, such as operating speeds, pressures, temperatures measured using other techniques, vibration levels, etc. In embodiments, the context data comprises events data associated with the detected object. Events data may include data that defines historic diagnostic codes and/or error codes reported for the asset 260.

In accordance with aspects of the invention, the plural anomaly detection models included in the anomaly detection model 245 are configured to detect (i.e., predict) anomalous behavior of the asset 260 based on one or more types of the additional information in the data sources 225. For example, a respective one of the models may be trained (e.g., using supervised learning with labeled historical temperature data) to predict that anomalous behavior will occur at a particular location in the asset 260 based on historical temperature data in the data sources 225. In another example, another respective one of the models may be trained (e.g., unsupervised learning using historic asset real-time condition data, historic maintenance history data, and historic events data) to predict that anomalous behavior will occur at a particular location in the asset 260 based on asset real-time condition data, maintenance history data, and events data in the data sources 225. These examples are not limiting, and other types of predictive anomaly detection models may be trained using training data of the same types of additional data included in the data sources 225. Once trained, these models may be used to predict anomalous behavior of the asset 260 by inputting the appropriate data from the data sources 225 into the model, with the output of the model being a prediction of anomalous behavior of the asset 260 at a particular location on the asset 260.

In embodiments, the anomaly detection model 245 generates an intermediate suggested ROI based on the particular location of the predicted anomalous behavior and the initial ROI. The anomaly detection module 245 may do this for each of the initial ROIs. The intermediate suggested ROI may comprise a modification of the initial ROI or may comprise a new ROI, and different criteria may be used to determine whether to modify the initial ROI or create a new ROI. In one example, if the particular location is sufficiently close to the initial ROI, then the anomaly detection model 245 modifies the initial ROI to include the particular location, and the modified ROI is referred to as the intermediate suggested ROI. In another example, if the particular location is sufficiently far away from the initial ROI, then the anomaly detection model 245 creates a new ROI that includes the particular location, and the new ROI is referred to as the intermediate suggested ROI. One or more thresholds that define sufficiently close and sufficiently far away may be pre-defined, e.g., as a user configurable value.

In accordance with aspects of the invention, the shape recommendation module 250 is configured to determine a shape of a suggested ROI using the intermediate suggested ROI and a shape recommendation model. The shape recommendation module 250 may do this for each of the intermediate suggested ROIs. In embodiments, the shape recommendation model determines the shape of the suggested ROI based on one or more optimization rules. The optimization rules may comprise business rules. In one example, the shape recommendation module 250 determines a shape of the suggested ROI based on a desired accuracy for the thermal analysis of the asset 260. In this example, the shape recommendation model includes three rules: (i) for high accuracy use an exact shape; (ii) for moderate accuracy use a rectangle; and (iii) for low accuracy use a point. In this example, if the desired accuracy for the thermal analysis of the asset 260 is high, then the shape recommendation module 250 generates a suggested shape that corresponds to the perimeter of a particular component in the optical image data. The suggested shape may have plural different sides and angles, and may resemble a free-form shape in its appearance. In this manner, the suggested ROI coincides nearly exactly with the view of the component in the optical image data, which provides the highest degree of accuracy for thermal monitoring of this component. In this example, if the desired accuracy for the thermal analysis of the asset 260 is moderate, then the shape recommendation module 250 generates a suggested shape in the form of a rectangle that surrounds the entire component as seen in the optical image data. In this example, if the desired accuracy for the thermal analysis of the asset 260 is low, then the shape recommendation module 250 generates a suggested shape in the form of a point (e.g., a single coordinate pair) at the particular location determined by the anomaly detection model 245.

In accordance with aspects of the invention, the selection rule module 255 is configured to determine a final ROI using the suggested ROI and a selection rule. In embodiments, the selection rule comprises comparing a confidence level of the suggested ROI to a threshold and performing a predefined action based on the comparing. In response to the confidence level of the suggested ROI being greater than the threshold, the selection rule module 255 automatically selects the suggested ROI as the final ROI. In response to the confidence level of the suggested ROI being less than the threshold, the selection rule module 255 provides the suggested ROI to a user via the user device 220 and determines the final ROI based on input from the user. For example, in the latter scenario, the selection rule module 255 may present the suggested ROI to the user via a display of the user device 220, and the user may provide input to either accept the suggested ROI or draw a different ROI. If the user accepts the suggested ROI, then the suggested ROI becomes the final ROI. If the user draws a different ROI, then that becomes the final ROI. In embodiments, the threshold is a predefined value that may be set by a user (via the user device 220) as a configuration parameter. In embodiments, the confidence level of the suggested ROI is aggregated from confidence levels determined by the object detection model and the anomaly detection model. The selection rule module 255 may generate a final ROI in this manner for each of the suggested ROIs.

In accordance with aspects of the invention, the ROI server 215 transmits data defining the final ROIs to the thermal camera 210. In this way, the thermal camera 210 may use the final ROIs when providing subsequent image data to the ROI server 215. In this manner, the system provides a closed loop that continually updates the ROIs used by the thermal camera 210 based on the final ROIs determined by the ROI server 215.

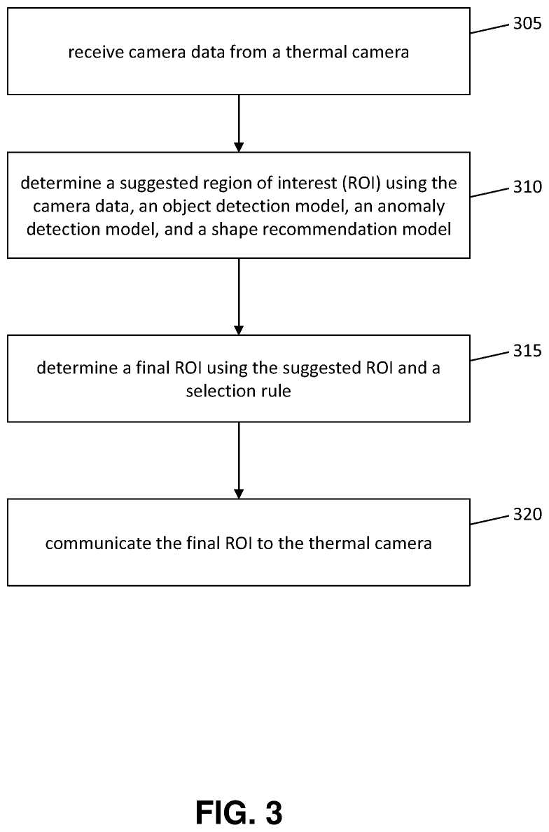

FIG. 3 shows a flowchart of an exemplary method in accordance with aspects of the present invention. Steps of the method may be carried out in the environment of FIG. 2 and are described with reference to elements depicted in FIG. 2.

At step 305, the system receives camera data from a thermal camera. In embodiments, and as described with respect to FIG. 2, the ROI server 215 receives camera data from the thermal camera. The camera data may comprise optical image data, thermal image data, and metadata, as described herein.

At step 310, the system determines a suggested region of interest (ROI) using the camera data, an object detection model, an anomaly detection model, and a shape recommendation model. In embodiments, the ROI server 215 determines the suggested ROI using the modules 235, 240, 245, and 250 as described with respect to FIG. 2.

At step 315, the system determines a final ROI using the suggested ROI and a selection rule. In embodiments, the ROI server 215 determines the suggested ROI using the module 255 as described with respect to FIG. 2.

At step 320, the system communicates the final ROI to the thermal camera. In embodiments, the ROI server 215 transmits data defining the final ROI to the thermal camera 210 as described with respect to FIG. 2.

In embodiments of the method, the camera data includes optical image data of an asset, thermal image data corresponding to the optical image data, and metadata corresponding to the optical image data and the thermal image data.

In embodiments, the method further comprises: detecting an object in the optical image data using the object detection model; generating an initial ROI based on the detecting the object; and extracting temperature information from the thermal image data in the initial ROI.

In embodiments of the method, the object detection model is trained using asset type information to detect predefined assets and components of the predefined assets.

In embodiments, the method further comprises generating an intermediate suggested ROI using the anomaly detection model with the initial ROI, the extracted temperature information, and additional information including collaborative data, content data, and context data.

In embodiments of the method, the anomaly detection model comprises an ensemble of plural anomaly detection models, and the intermediate suggested ROI is generated using a highest-ranked one of the plural anomaly detection models.

In embodiments of the method, the collaborative data comprises data from a same family of asset as the detected object. In embodiments of the method, the content data comprises one or more selected from a group consisting of: manufacturer information or specifications of the asset; maintenance history data of the asset; historical temperature data of the asset; and real-time condition data of the asset. In embodiments of the method, the context data comprises events data associated with the asset.

In embodiments, the method further comprises determining a shape of the suggested ROI using the intermediate suggested ROI and the shape recommendation model.

In embodiments of the method, the shape recommendation model determines the shape of the suggested ROI based on one or more optimization rules.

In embodiments of the method, the determining the final ROI comprises: comparing a confidence level of the suggested ROI to a threshold; in response to the confidence level of the suggested ROI being greater than the threshold, automatically selecting the suggested ROI as the final ROI; and in response to the confidence level of the suggested ROI being less than the threshold, providing the suggested ROI to a user via a user device and determining the final ROI based on input from the user.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, camera data from a thermal camera;
determining, by the processor set, a suggested region of interest (ROI) using the camera data, an object detection model, an anomaly detection model, and a shape recommendation model;
determining, by the processor set, a final ROI using the suggested ROI and a selection rule; and
communicating, by the processor set, the final ROI to the thermal camera.

2. The computer-implemented method of claim 1, wherein the camera data includes optical image data of an asset, thermal image data corresponding to the optical image data, and metadata corresponding to the optical image data and the thermal image data.

3. The computer-implemented method of claim 2, further comprising:
detecting an object in the optical image data using the object detection model;
generating an initial ROI based on the detecting the object; and
extracting temperature information from the thermal image data in the initial ROI.

4. The computer-implemented method of claim 3, wherein the object detection model is trained using asset type information to detect predefined assets and components of the predefined assets.

5. The computer-implemented method of claim 3, further comprising generating an intermediate suggested ROI using the anomaly detection model with the initial ROI, the extracted temperature information, and additional information including collaborative data, content data, and context data.

6. The computer-implemented method of claim 5, wherein:
the anomaly detection model comprises an ensemble of plural anomaly detection models; and
the intermediate suggested ROI is generated using a highest-ranked one of the plural anomaly detection models.

7. The computer-implemented method of claim 5, wherein:
the collaborative data comprises data from a same family of asset as the detected object;
the content data comprises one or more selected from a group consisting of: manufacturer information or specifications of the asset; maintenance history data of the asset; historical temperature data of the asset; and real-time condition data of the asset; and
the context data comprises events data associated with the asset.

8. The computer-implemented method of claim 5, further comprising determining a shape of the suggested ROI using the intermediate suggested ROI and the shape recommendation model.

9. The computer-implemented method of claim 8, wherein the shape recommendation model determines the shape of the suggested ROI based on one or more optimization rules.

10. The computer-implemented method of claim 8, wherein the determining the final ROI comprises:
comparing a confidence level of the suggested ROI to a threshold;
in response to the confidence level of the suggested ROI being greater than the threshold, automatically selecting the suggested ROI as the final ROI; and
in response to the confidence level of the suggested ROI being less than the threshold, providing the suggested ROI to a user via a user device and determining the final ROI based on input from the user.

11. A computer program product comprising one or more computer readable storage media having program instructions collectively stored on the one or more computer readable storage media, the program instructions executable to:
receive camera data from a thermal camera;
determine a suggested region of interest (ROI) using the camera data, an object detection model, an anomaly detection model, and a shape recommendation model;
determine a final ROI using the suggested ROI and a selection rule; and
communicate the final ROI to the thermal camera.

12. The computer program product of claim 11, wherein:
the camera data includes optical image data of an asset, thermal image data corresponding to the optical image data, and metadata corresponding to the optical image data and the thermal image data; and
the program instructions are executable to: detect an object in the optical image data using the object detection model; generate an initial ROI based on the detecting the object; and extract temperature information from the thermal image data in the initial ROI.

13. The computer program product of claim 12, wherein the program instructions are executable to generate an intermediate suggested ROI using the anomaly detection model with the initial ROI, the extracted temperature information, and additional information.

14. The computer program product of claim 13, wherein:
the program instructions are executable to determine a shape of the suggested ROI using the intermediate suggested ROI and the shape recommendation model; and
the shape recommendation model determines the shape of the suggested ROI based on one or more optimization rules.

15. The computer program product of claim 14, wherein the determining the final ROI comprises:
comparing a confidence level of the suggested ROI to a threshold;
in response to the confidence level of the suggested ROI being greater than the threshold, automatically selecting the suggested ROI as the final ROI; and
in response to the confidence level of the suggested ROI being less than the threshold, providing the suggested ROI to a user via a user device and determining the final ROI based on input from the user.

16. A system comprising:
a processor set, one or more computer readable storage media, and program instructions collectively stored on the one or more computer readable storage media, the program instructions executable to:
receive camera data from a thermal camera;
determine a suggested region of interest (ROI) using the camera data, an object detection model, an anomaly detection model, and a shape recommendation model;
determine a final ROI using the suggested ROI and a selection rule; and
communicate the final ROI to the thermal camera.

17. The system of claim 16, wherein:
the camera data includes optical image data of an asset, thermal image data corresponding to the optical image data, and metadata corresponding to the optical image data and the thermal image data; and
the program instructions are executable to: detect an object in the optical image data using the object detection model; generate an initial ROI based on the detecting the object; and extract temperature information from the thermal image data in the initial ROI.

18. The system of claim 17, wherein the program instructions are executable to generate an intermediate suggested ROI using the anomaly detection model with the initial ROI, the extracted temperature information, and additional information.

19. The system of claim 18, wherein:
the program instructions are executable to determine a shape of the suggested ROI using the intermediate suggested ROI and the shape recommendation model; and
the shape recommendation model determines the shape of the suggested ROI based on one or more optimization rules.

20. The system of claim 19, wherein the determining the final ROI comprises:
comparing a confidence level of the suggested ROI to a threshold;
in response to the confidence level of the suggested ROI being greater than the threshold, automatically selecting the suggested ROI as the final ROI; and
in response to the confidence level of the suggested ROI being less than the threshold, providing the suggested ROI to a user via a user device and determining the final ROI based on input from the user.
